(19) United States
(12) Patent Application Publication
(10) Pub. No.: US 2015/0056595 A1
(43) Pub. Date: Feb. 26, 2015

(54) SYSTEMS AND METHODS FOR DIAGNOSIS AND TREATMENT OF PSYCHIATRIC DISORDERS

(71) Applicant: The Curators of the University of Missouri, Columbia, MO (US)

(72) Inventors: Ganesh GOPALAKRISHNA, Columbia, MO (US); Sriram CHELLAPPAN, Rolla, MO (US)

(73) Assignee: The Curators of the University of Missouri, Columbia, MO (US)

(21) Appl. No.: 13/974,274

(22) Filed: Aug. 23, 2013

(51) Int. Cl. G09B 7/00

(52) U.S. Cl. CPC G09B 7/00
USPC 434/322

(57) ABSTRACT

A device for diagnosing and treating psychiatric disorders is described. The device may be configured to provide a graphical user interface that enables a user to select at least one of: entering information related to a diagnosis of the psychiatric disorder and alleviating symptoms caused by the psychiatric disorder. Upon a user selecting entering information related to the diagnosis of a psychiatric disorder, the device may receive information related to the diagnosis of the psychiatric disorder. The device may determine the severity of a user's condition based at least in part on the received information. The device may provide a treatment based on the determined severity of the user's condition. A treatment may include providing feedback to a user.

### TECHNICAL FIELD

This disclosure relates to systems and methods for diagnosing and treating psychiatric disorders and more particularly to providing a device that may be used to diagnose and treat psychiatric disorders.

### BACKGROUND

Psychiatric disorders are serious medical conditions that have detrimental effects to the mental and physical well-being of individuals. Psychiatric disorders include, for example, depression, anxiety, stress, and anorexia. Psychiatric disorders are a significant problem for a substantial portion of the population. A survey conducted by the Centers for Disease Control (CDC) in 2009 found that 26.1% of college students in the United States reported feeling so sad or hopeless almost every day for two or more consecutive weeks that they stopped doing some usual activities.

Although there are treatments available for psychiatric disorders, many individuals do not recognize symptoms and/or may be reluctant to seek available treatments. If left untreated, psychiatric disorders can lead to suicidal and/or violent behavior. Thus, there is a need in the United States for early detection of psychiatric disorders and for providing individuals suffering from psychiatric disorders convenient access to available treatments. Further, in countries other than the United States, there is a need to provide individuals suffering from psychiatric disorders access to resources that may be used to diagnose and treat psychiatric disorders.

### SUMMARY

In general, this disclosure describes techniques for diagnosing and treating psychiatric disorders. In particular, this disclosure describes techniques for providing a device to an individual, wherein the device is configured to provide resources for diagnosing and treating one or more psychiatric disorders. In some examples, the device may be a mobile device, for example, a smart phone. By providing resources as a feature of a mobile device, access to diagnostic and treatment resources may be increased. Further, a device configured to provide diagnostic and treatment resources may also be configured to provide information to a health care professional, such that, for example, the health care professional can receive real-time data associated with an individual's condition. In this manner, a device may provide an interface between a patient and a healthcare professional, such that the patient and healthcare professional can communicate between clinical visits. In some examples, data may be provided to a healthcare professional using a graphical representation. Further, a device may be configured to provide user feedback information that the user may use to treat a psychiatric disorder.

According to one example of the disclosure, a method for diagnosing and treating psychiatric disorders comprises providing a graphical user interface that enables a user to select at least one of: entering information related to a diagnosis of a psychiatric disorder and alleviating symptoms caused by the psychiatric disorder, and upon the user selecting entering information related to the diagnosis of a psychiatric information, receiving information related to the diagnosis of the psychiatric disorder, determining the severity of a user's condition based at least in part on the received information, and providing a treatment based on the determined severity of the user's condition.

According to another example of the disclosure a device for diagnosing and treating a psychiatric disorder, comprises one or more processors configured to: provide a graphical user interface that enables a user to select at least one of: entering information related to a diagnosis of the psychiatric disorder and alleviating symptoms caused by the psychiatric disorder, and upon the user selecting entering information related to the diagnosis of a psychiatric disorder, receive information related to the diagnosis of the psychiatric disorder, determine the severity of a user's condition based at least in part on the received information, and provide a treatment based on the determined severity of the user's condition.

According to another example of the disclosure a non-transitory computer-readable storage medium has instructions stored thereon that upon execution cause one or more processors of a device to provide a graphical user interface that enables a user to select at least one of: entering information related to a diagnosis of the psychiatric disorder and alleviating symptoms caused by the psychiatric disorder, and upon the user selecting entering information related to the diagnosis of a psychiatric disorder, receive information related to the diagnosis of the psychiatric disorder, determine the severity of a user's condition based at least in part on the received information; and provide a treatment based on the determined severity of the user's condition.

According to another example of the disclosure an apparatus for diagnosing and treating psychiatric disorders comprises means for providing a graphical user interface that enables a user to select at least one of: entering information related to a diagnosis of a psychiatric disorder and alleviating symptoms caused by the psychiatric disorder, and means for upon the user selecting entering information related to the diagnosis of a psychiatric information, receiving information related to the diagnosis of the psychiatric disorder, determining the severity of a user's condition based at least in part on the received information, and providing a treatment based on the determined severity of the user's condition.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that may implement one or more techniques of this disclosure.

FIG. 2 is a block diagram illustrating an example of a computing device that may implement one or more techniques of this disclosure.

FIG. 3 is a conceptual diagram illustrating an example of an application for treating and diagnosing a psychiatric disorder in accordance with one or more techniques of this disclosure.

FIG. 4 is an example of a graphical user interface that may be provided by a computing device to implement one or more techniques of this disclosure.

FIG. 5 is an example of a graphical user interface that may be provided by a computing device to implement one or more techniques of this disclosure.

FIG. 6 is an example of a graphical user interface that may be provided by a computing device to implement one or more techniques of this disclosure.

FIG. 7 is an example of a graphical user interface that may be provided by a computing device to implement one or more techniques of this disclosure.

FIG. 8A is an example of a graphical user interface that may be provided by a computing device to implement one or more techniques of this disclosure.

FIG. 8B is an example of a graphical user interface that may be provided by a computing device to implement one or more techniques of this disclosure.

FIG. 9 is an example of a graphical user interface that may be provided by a computing device to implement one or more techniques of this disclosure.

FIG. 10 is an example of a graphical user interface that may be provided by a computing device to implement one or more techniques of this disclosure.

FIG. 11 is an example of a graphical user interface that may be provided by a computing device to implement one or more techniques of this disclosure.

FIG. 12 is an example of a graphical user interface that may be provided by a computing device to implement one or more techniques of this disclosure.

FIG. 13 is an example of a graphical user interface that may be provided by a computing device to implement one or more techniques of this disclosure.

FIG. 14 is an example of a graphical user interface that may be provided by a computing device to implement one or more techniques of this disclosure.

FIG. 15 is an example of a graphical user interface that may be provided by a computing device to implement one or more techniques of this disclosure.

FIG. 16 is an example of a graphical user interface that may be provided by a computing device to implement one or more techniques of this disclosure.

FIG. 17 is a flowchart illustrating an example method for diagnosing and treating a psychiatric disorder according to the techniques of this disclosure.

FIG. 18 is an example of a graphical user interface that may be provided by a computing device to implement one or more techniques of this disclosure.

### DETAILED DESCRIPTION

In general, this disclosure describes techniques for diagnosing and treating one or more psychiatric disorders. Psychiatric disorders may include mental disorders defined in the International Classification of Disease produced by the World Health Organization and/or mental disorders defined in the Diagnostic and Statistical Manual of Mental Disorders produced by the American Psychiatric Association. Psychiatric disorders may also include mental disorders defined by other classification systems. Psychiatric disorders include, for example, depression, anxiety, stress, anorexia, bipolar disorder, and schizophrenia. Psychiatric disorders are typically diagnosed and treated during one or more clinical visits. In some cases, psychiatric disorders, such as depression, are diagnosed using questionnaires, such as the Center for Epidemiologic Studies Depression Scale (CESD-R), which may be administered using the CESD-R website, and the Patient Health Questionnaire (PHQ-9) developed by Pfizer. The CESD-R measures symptoms defined by the American Psychiatric Association Diagnostic and Statistical Manual (DSM-IV) for a major depressive episode. While some psychiatric disorders may be effectively diagnosed and treated by having a patient and psychiatrist meet only during regularly scheduled visits, in some cases it may be more effective to have a patient and healthcare professional interact more frequently based on behavior the patient is displaying at a particular time. The techniques described herein provide an effective interface between patients and healthcare professionals and include intervention strategies to temporarily alleviate patient mood when problematic behavior is identified.

In one example, the techniques may be implemented as part of a mobile device application. In one example, healthcare professionals may advise their patients to report behavior using a mobile device application, so that problematic behavior associated with a psychiatric disorder can be diagnosed and treated between regularly scheduled clinical visits. In this manner, the techniques described herein may provide a large number of people with personalized, efficient and reliable mental health care.

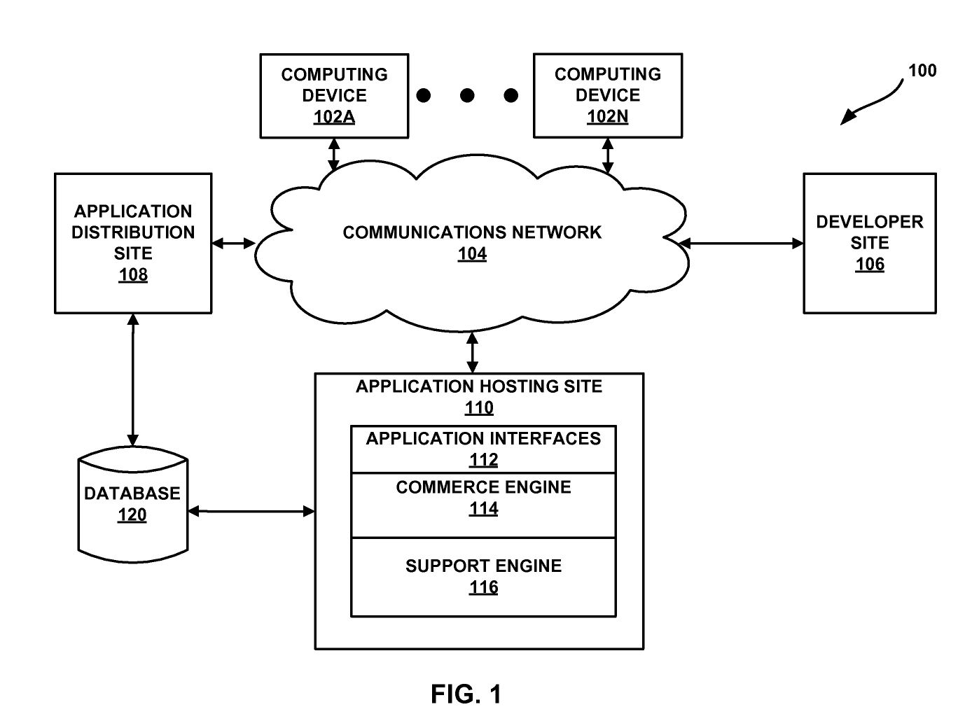

FIG. 1 is a block diagram illustrating an example system that may implement one or more techniques of this disclosure. System 100 may be configured to treat and diagnose psychiatric disorders in accordance with the techniques described herein. In the example illustrated in FIG. 1, system 100 includes one or more computing devices 102A-102N, communications network 104, developer site 106, application distribution site 108, and application hosting site 110. Application hosting site 110 may include application interface 112, commerce engine 114, and support engine 116. Further, as illustrated in FIG. 1, application distribution site 108 and application hosting site 110 may be connected to database 120. System 100 may include software modules operating on one or more servers. Software modules may be stored in a memory and executed by a processor. Servers may include one or more processors and a plurality of internal and/or external memory devices. Examples of memory devices include file servers, an FTP servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to allow software applications to be developed, distributed, and executed on a plurality of computing devices, such as computing devices 102A-102N. In the example illustrated in FIG. 1, computing devices 102A-102N may respectively include any device configured to transmit data to and receive data from communication network 104. For example, computing devices 102A-102N may be equipped for wired and/or wireless communications and may include desktop or laptop computers, mobile devices, smartphones, cellular telephones, set top boxes, and personal gaming devices.

Communications network 104 may comprise any combination of wireless and/or wired communication media. Communication network 104 may include routers, switches, base stations, or any other equipment that may be useful to facilitate communication between various devices and sites. Communication network 104 may form part of a packet-based network, such as a local area network, a wide-area network, or a global network such as the Internet. Communication network 104 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 1, developer site 106 is connected to communications network 104. Developer site 106 may be configured to enable one or more software developers to author, maintain, update, improve, and/or monitor software applications. Developer site 106 may be part of an organization that provides software applications. In the example where computing devices 102A-102N are mobile devices, such as, for example, smartphones, developer site 106 may be configured to provide software applications for use with a mobile device. Software applications for use with a mobile device may be referred to as apps. Developer site 106 may include one or more developer workstations (not shown) in communication with one another. Developer workstations may include any device such as, a laptop or a desktop computer capable of coding software functions. Developer workstations may include computers running an operation system, such as, for example, Linux, and/or operation systems developed by Microsoft and Apple. Developer site 106 may include any combination of hardware and software that enables developers to code software according to a specified programming language. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Pert, UNIX Shell, Visual Basic or Visual Basic Script, Virtual Reality Markup Language (VRML), ColdFusion™ and other compilers, assemblers, and interpreters. In some examples, developers may write software applications using a software development kit (SDK) provided by a device manufacturer or a data service provider.

As illustrated in FIG. 1, application distribution site 108 is connected to communications network 104. Application distribution site 108 may be configured to receive a developed software application and distribute a developed application to computing devices 102A-102N. Further, in some examples, application distribution site 108 may be configured to distribute supporting software to hosting site 110. In the example where one or more of computing devices 102A-102N are mobile devices, application distribution site 108 may be maintained by a mobile device manufacturer, a service provider, and/or a mobile device operating system provider. An application distribution site that is maintained by a mobile device manufacturer, a service provider, or a mobile device operating system provider may be referred to as an app store. Examples of app stores include Google Play, the Apple App Store, BlackBerry World, Windows Phone Store, and the Amazon Appstore.

As illustrated in FIG. 1, application hosting site 110 is connected to communications network 104. Application hosting site 110 is configured to support the operation of a software application on one or more of computing devices 102A-102N. For example, if a software application provides interaction between two or more of computing devices 102A-102N (e.g., a patient computing device and a healthcare professional computing device), application hosting site 110 may be configured to support interaction between computing devices 102A-102N. In the example illustrated in FIG. 1, application hosting site 110 includes application interface 112, commerce engine 114, and support engine 116. Application interface 112, commerce engine 114, and support engine 116 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

Application interface 112 may be configured to provide an interface between application hosting site 110 and one or more of computing devices 102A-102N for a hosted aspect of an application. For example, if an application is an application for treating and diagnosing psychiatric disorders in accordance with the techniques described herein, application interface 112 may provide a log-in screen and validate user credentials in the example where the application allows a healthcare professional to view patient information or allows a patient to transmit information to the healthcare professional. Commerce engine 114 may be configured to support transactions that may occur when a user uses a software application. Commerce engine 114 may include a number of components required for online commerce. For example, commerce engine 114 may include modules with instructions stored on a computer readable medium that when executed by a processor cause application hosting site 110 to perform functions related to customer accounts, orders, subscriptions, tax, payments, fraud, and credit processing. In the example where an application is an application for treating and diagnosing psychiatric disorders in accordance with the techniques described herein, commerce engine 114 may support any pay-per-use functions associated with the application.

Support engine 116 may be configured to provide support services associated with an application. In the example, where an application is an application for diagnosing and treating psychiatric disorders, support engine 116 may be configured to provide updates to an application installed on one of user devices 102A-102N. For example, support engine 116 may be configured to allow hosting site 110 to provide new questionnaires, new diagnosis algorithms, and new patient intervention options to one or more of computing devices 102A-102N. In the example where updates are pay-per-use updates, support engine 116 and commerce engine 114 may interact and/or may be highly integrated. As illustrated in FIG. 1, database 120 is connected to application hosting site 110 and application distribution site 108. Database 120 may include any of the memory device described above. Database 120 may store information associated with the operation of an application. For example database 120 may store user account information, multimedia associated with an application, and/or user credentials. In the example, where an application is an application for treating and diagnosing psychiatric disorders, database 120 may store medical records associated with patients.

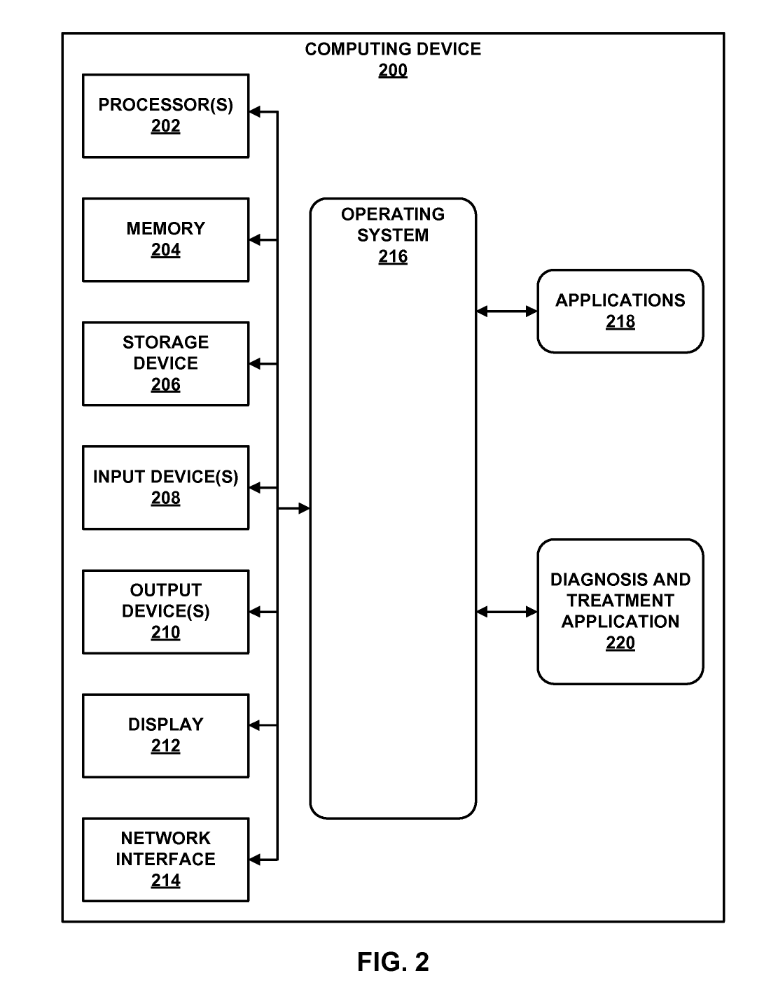

FIG. 2 is a block diagram illustrating an example of a computing device that may implement one or more techniques of this disclosure. Computing device 200 is an example of a computing device that may be configured to transmit data to and receive data from communication network 104 and execute one or more applications (e.g., diagnosis and treatment application 220). Computing device 200 may include or be part of a portable computing device (e.g., a mobile phone, netbook, laptop, personal data assistant (PDA), or tablet device) or a stationary computer (e.g., a desktop computer, or set-top box), or may be another computing device. Computing device 200 includes processor(s) 202, memory 204, storage device 206, input device(s) 208, output device(s) 210, display 212, and network interface 214. Each of processor(s) 202, memory 204, storage device 206, input device(s) 208, output device(s) 210, display 212, and network interface 214 may be interconnected (physically, communicatively, and/or operatively) for inter-component communications. Operating system 216, applications 218, and diagnosis and treatment application 220 may be executable by computing device 200. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204 or storage device 206. Processor(s) 202 may be digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. As described above, memory 204 may be used to store program instructions for execution by processor(s) 202 and may be used by software or applications running on computing device 200 to temporarily store information during program execution. For example, memory 204 may store instructions associated with operating system 216, applications 218, and diagnosis and treatment application 220 or components thereof, and/or memory 204 may store information associated with the execution of operating system 216, applications 218, and diagnosis and treatment application 220. Memory 204 may be described as a non-transitory or tangible computer-readable storage medium. In some examples, memory 204 may provide temporary memory and/or long-term storage. In some examples, memory 204 or portion thereof may be described as volatile memory, i.e., in some cases memory 204 may not maintain stored contents when computing device 200 is powered down. Examples of volatile memories include random access memories (RAM), dynamic random access memories (DRAM), and static random access memories (SRAM).

Storage device 206 represents memory of computing device that may be configured to store relatively larger amounts of information for relatively longer periods of time than memory 204. Similar to memory 204, storage device 206 may also include one or more non-transitory or tangible computer-readable storage media. Storage device 206 may be internal or external memory and in some examples may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 208 may be configured to receive input from a user operating computing device 200. Input from a user may be generated as part of a user running one or more software applications, such as applications 218 and/or diagnosis and treatment application 220. Input device(s) 208 may include a touch-sensitive screen, track pad, track point, mouse, a keyboard, a microphone, video camera, or any other type of device configured to receive input from a user. In one example, input device(s) 208 may generate one or more signals corresponding to the coordinates of a position touched on a touchscreen of computing device 200. These signals may be provided as information to components of computing device 200 (e.g., processor 202, or operating system 216) in conjunction with the execution of applications 218 and/or diagnosis and treatment application 220.

Output device(s) 210 may be configured to provide output to a user operating computing device 200. Output may tactile, audio, or visual output generated as part of a user running one or more software applications, such as applications 218 and/or diagnosis and treatment application 220. Output device(s) 210 may include a touch-sensitive screen, sound card, a video graphics adapter card, or any other type of device for converting a signal into an appropriate form understandable to humans or machines. Additional examples of an output device(s) 210 may include a speaker, a cathode ray tube (CRT) monitor, a liquid crystal display (LCD), or any other type of device that can provide output to a user. In some examples, output device(s) 210 may be external to computing device 200 and may be operatively coupled to computing device 200 using a standardized communication protocol, such as for example, Universal Serial Bus protocol (USB) or High-Definition Multimedia Interface (HDMI).

In the example illustrated in FIG. 2, computing device 200 includes display 212. In the example where computing device 200 is a mobile device, display 212 may be an integrated touch-screen display. For example, display 212 may be an LCD or organic light emitting diode (OLED) display configured to receive user touch inputs, such as, for example, taps, drags, and pinches. Thus, display 212 may be considered as a particular type of input and output device of computing device 200. Display 212 may be configured to allow a user to interact with diagnosis and treatment application 220, as describe in detail below.

Network interface 214 may be configured to enable computing device 200 to communicate with external devices via one or more networks, such as communications network 104. Network interface 214 may be a network interface card, such as an Ethernet card, an optical transceiver, a radio frequency transceiver, or any other type of device that can send and receive information. Network interface 214 may be configured to operate according to one or more of the communication protocols described above with respect to communications network 104. In one example, network interface 214 may enable a patient computing device running diagnostic and treatment application 220 to transmit information a healthcare professional.

Operating system 216 may be configured facilitate the interaction of applications, such as application 218 and diagnosis and treatment application 220, with processor(s) 202, memory 204, storage device 206, input device(s) 208, output device(s) 210, display 212, network interface 214 and other hardware components of computing device 200. Operating system 216 may be an operating system designed to be installed on laptops and desktops. For example, operating system 216 may be a Windows operating system, Linux, or Mac OS. In another example, if computing device 200 is a mobile device, such as a smartphone or a tablet, operating system 216 may be one of Android, iOS or a Windows mobile operating system.

Applications 218 may be any applications implemented within or executed by computing device 200 and may be implemented or contained within, operable by, executed by, and/or be operatively/communicatively coupled to components of computing device 200, e.g., processor(s) 202, memory 204, and network interface 214. In one example, an application may be developed by developer site 106 as described above with respect to FIG. 1. Applications 218 may include instructions that may cause processor(s) 202 of computing device 200 to perform particular functions. Applications 218 may include algorithms which are expressed in computer programming statements, such as, for loops, while-loops, if-statements, do-loops, etc.

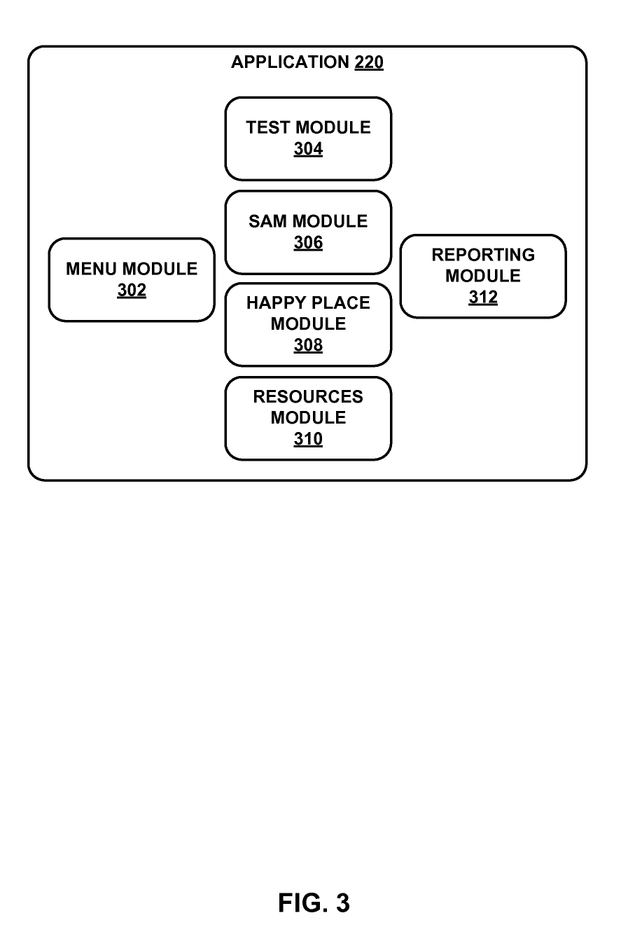

Diagnosis and treatment application 220 is an example of an application configured to diagnose and treat a psychiatric disorder according to the techniques described herein. FIG. 3 is a conceptual diagram illustrating an example of a diagnosis and treatment application 220. As illustrated in FIG. 3, diagnosis and treatment application 220 includes menu module 302, test module 304, sleep, activity, mood (SAM) module 306, happy place module 308, resources module 310 and reporting module 312. Modules illustrated in FIG. 3 may be software modules and/or may be implemented using any combination of hardware, software, or firmware. In one example, modules illustrated in FIG. 3 may be software stored locally on computing device 200 (e.g., modules may be stored on memory 204 and/or storage device 206). In other examples, the modules illustrated in FIG. 3 may be software modules and/or portions thereof may be distributed throughout system 100. For example, test module 304 may be stored on computing device 200 and reporting module may be stored on application hosting site 110.

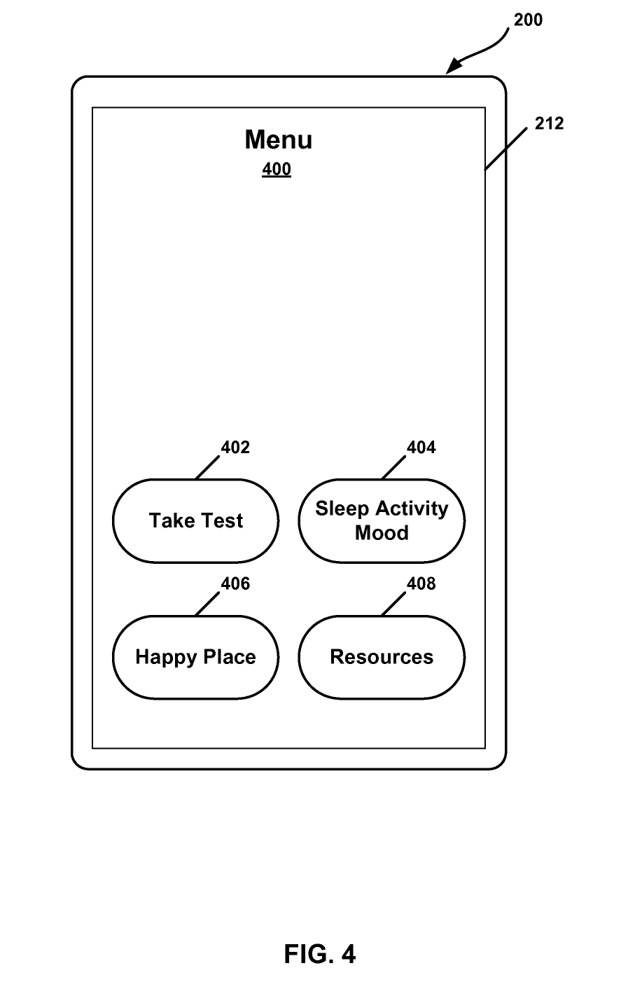

Menu module 302 is configured to allow a user of diagnosis and treatment application 220 to select one of a plurality functions associated with the operation of application. FIG. 4 is an example of a graphical user interface that may be provided by a computing device to implement one or more techniques of this disclosure. The graphical user interface illustrated in FIG. 4 represents an example of a graphical user interface that may be provided in conjunction with functions associated with menu module 302. In one example, graphical user interface 400 may be the graphical user interface that is initially displayed during the operation of diagnosis and treatment application 220. In one example, a user may be initially presented with a log-in screen and menu graphical user interface 400 may be presented after credentials are successfully validated. Log-in credentials may be successfully validated by support engine 116, as described above.

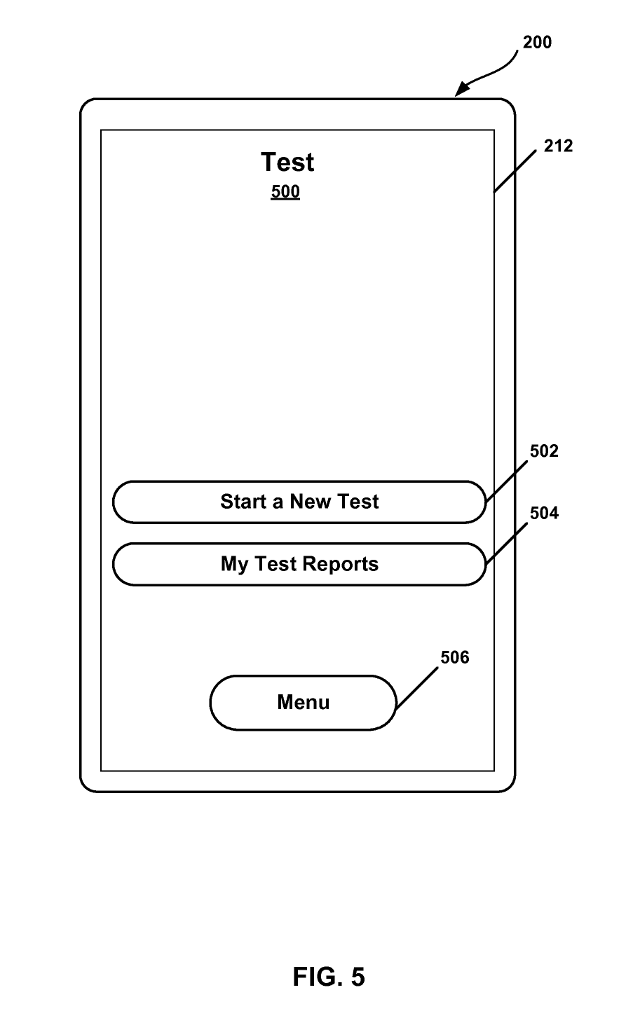

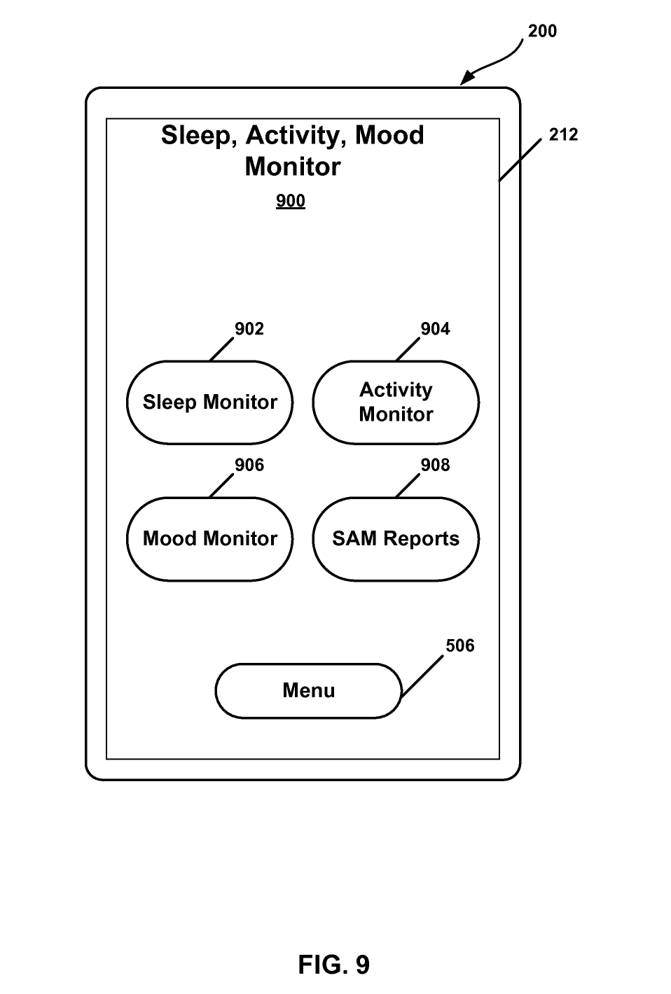

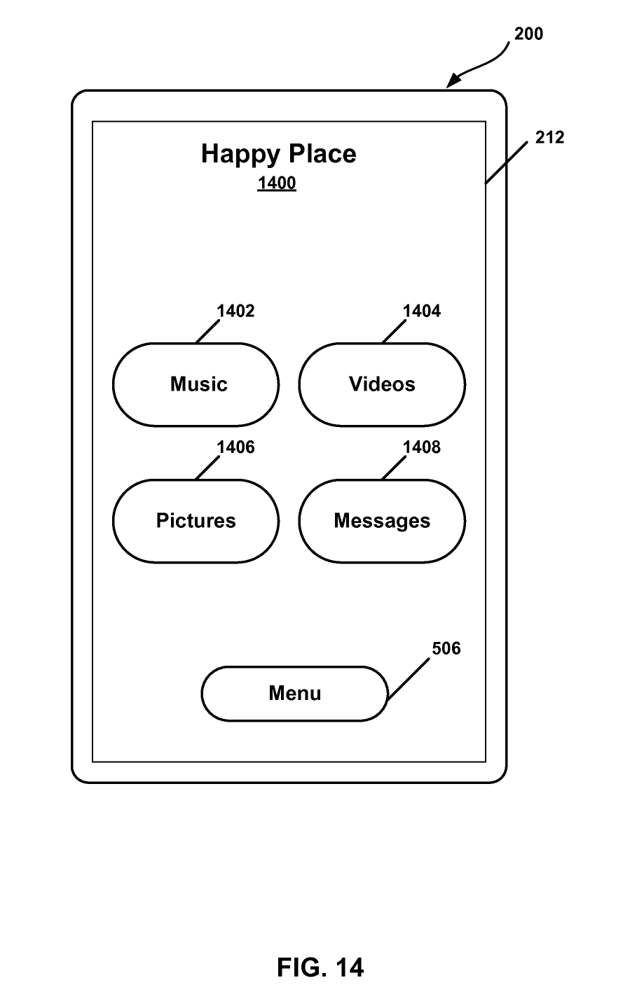

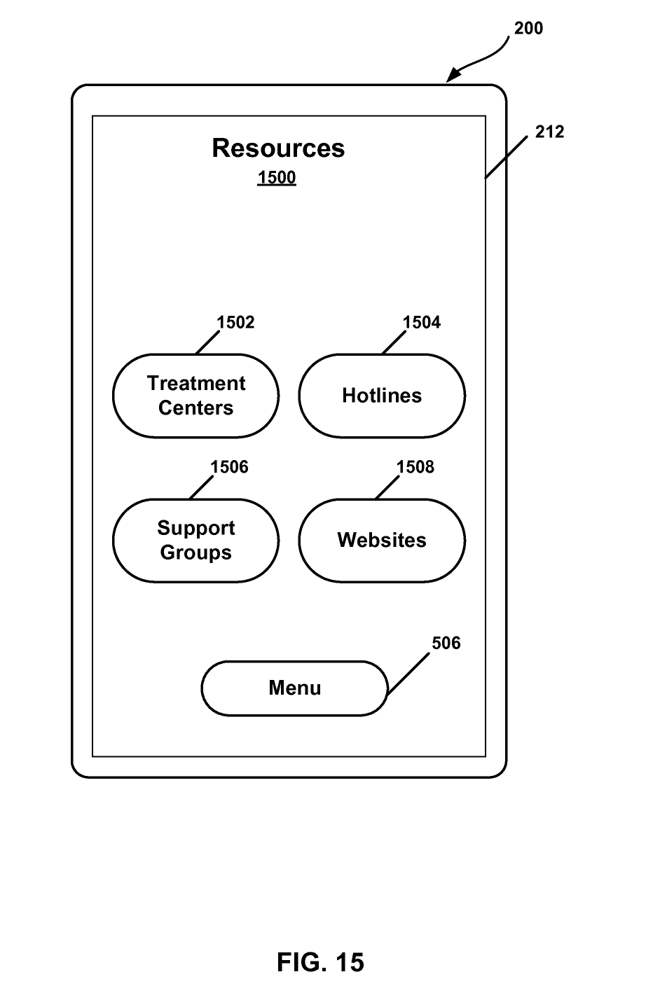

As illustrated in FIG. 4, menu graphical user interface 400 includes take test icon 402, sleep activity mood icon 404, happy place icon 406, and resources icon 408. A user of computing device 200 may select one of test icon 402, sleep activity mood icon 404, happy place icon 406, or resources icon 408 using input device(s) 208 (e.g., tapping a touch-sensitive display). Upon selection of one of test icon 402, sleep activity mood icon 404, happy place icon 406, or resources icon 408 by a user, computing device 200 will respectively provide one of: test graphical user interface 500 illustrated in FIG. 5, sleep, activity, mood monitor graphical user interface 900 illustrated in FIG. 9, happy place graphical user interface 1400 illustrated in FIG. 14, or resources graphical user interface 1500 illustrated in FIG. 15. As described in detail below, test graphical user interface 500 and mood monitor graphical user interface 900 enable a user to enter information related to a diagnosis of a psychiatric disorder and happy place graphical user interface 1400 and resources graphical user interface 1500 enable a user to alleviate symptoms associated with a psychiatric disorder.

FIGS. 5-8B are examples of graphical user interfaces that may be provided by a computing device to implement one or more techniques of this disclosure. The graphical user interfaces illustrated in FIG. 5-8B represent examples of graphical user interface(s) that may be provided in conjunction with functions associated with test module 304. Test module 304 is configured to allow a user to take a screening test for a psychiatric disorder. In one example, a psychiatric disorder may be depression and a screening test may be a validated questionnaire used to assess symptoms of depression. Test module 304 may use one or more algorithms to score a questionnaire (e.g., a weighted sum of user answers). A screening test may be the CESD-R questionnaire, PHQ-9 questionnaire, a combination thereof, or another type of questionnaire or survey that has been extensively validated to assess symptoms of a psychiatric disorder. Upon completion of a test, a user's test results may be recorded and stored. If a user's results indicate a serious psychiatric disorder (e.g., suicidal tendencies), test module 302 may provide appropriate intervention (e.g., instruct the user to immediately call a suicide hotline).

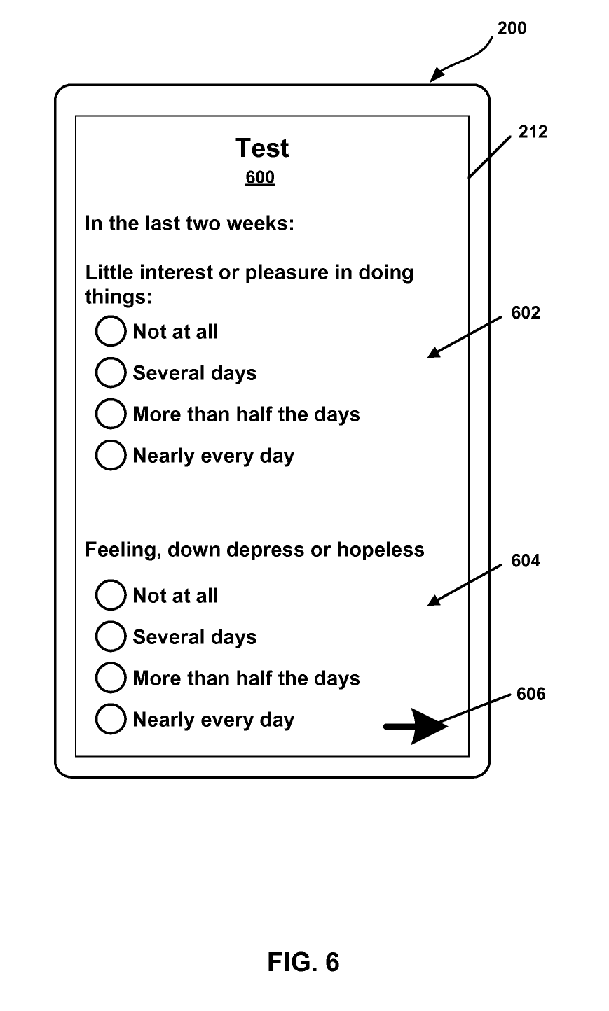

As illustrated in FIG. 5, test graphical user interface 500 includes start a new test icon 502, my test reports icon 504, and menu icon 506. Upon selection of start a new test icon 502 by a user, computing device 200 will provide test graphical user interface 600 illustrated in FIG. 6. Upon selection of my test reports icon 504, computing device 200 will provide test results of tests previously completed by a user. Upon selection of menu icon 506, computing device 200 will return user to menu graphical user interface 400. As described above, in one example, a screening test may include a questionnaire.

Test graphical user interface 600 represents an example of a screening test questionnaire that may be provided to a user. As illustrated in FIG. 6, test graphical user interface 600 includes questions and answers selections 602 and 604 (e.g., radio buttons) and next questions icon 606. A user may enter the most appropriate selection corresponding to each of questions 602 and 604. In one example, instructions such as, “At the top of each of the following screens, you will see a statement. For each statement, please indicate how often you have felt this way recently by selecting the option you most agree with,” may be provided to a user. After a user completes questions that appear on display 212, user may select next questions icon 606 and one or more additional graphical user interfaces including questions may be presented to a user until a user reaches the end of a test. In some cases, a test may include between five to twenty questions.

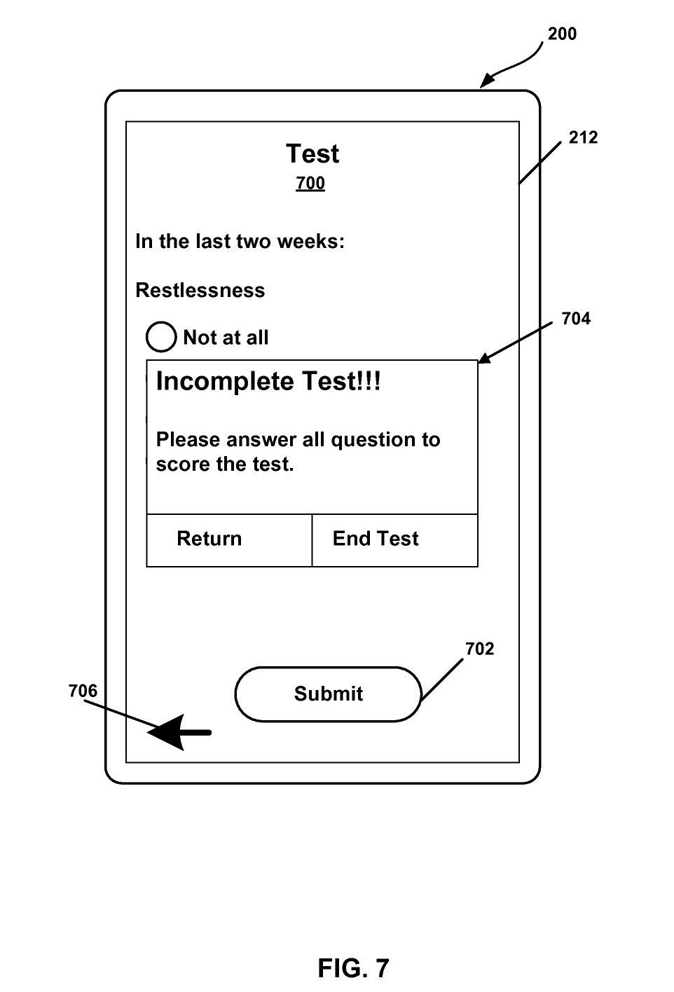

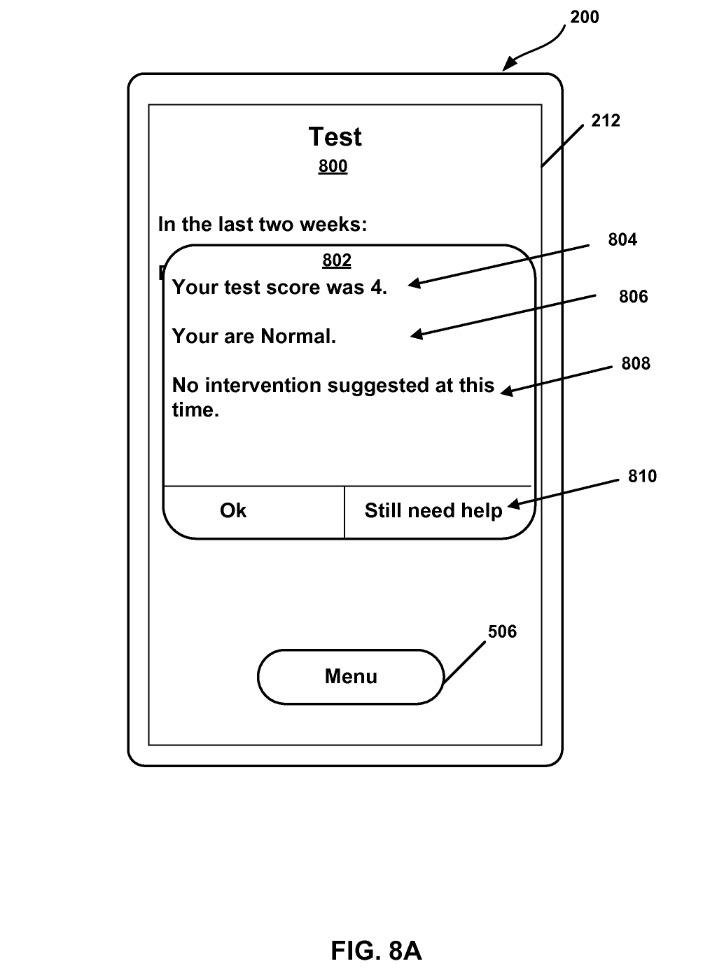

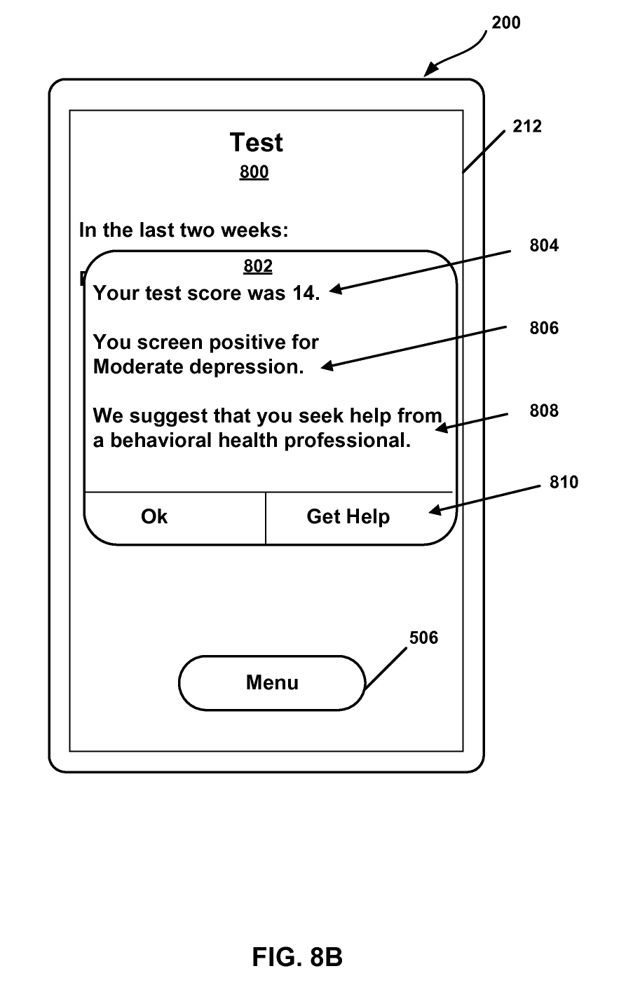

FIG. 7 illustrates an example of a graphical user interface that may be provided to a user as a graphical user interface including the final questions of a test. As illustrated in FIG. 7, test graphical user interface 700 includes submit icon 702, incomplete test window 704, and previous questions icon 706. In one example, upon selection of submit icon 702, incomplete test window 704 will appear if all questions have not been answered and test graphical user interface 800 illustrated in FIGS. 8A-8B will be provided if all questions have been answered. As illustrated in FIG. 7, incomplete test window 704 informs a user that a test is incomplete because all of the questions have not been answered. When the incomplete test window 704 appears, a user may close the incomplete test window 704 by selecting Return, which will return the user to the application state prior to the submit icon being selected or a user may select End Test which may return a user to menu graphical user interface 400 or test module 302 may attempt to score an incomplete test and test graphical user interface 800 may be provided.

As illustrated in FIGS. 8A-8B, test graphical user interface 800 includes results window 802. Results window 802 includes test score statement 804, diagnosis statement 806, treatment statement 808, and user selection buttons 810, each of which may be based on a user's test result. In one example, a depression screening test may have a total score of 0 to 27, where each answer to a question contributes a value to the total score according to an algorithm, such as a weighted sum formula. In one example, the weighted sum formula may be similar to those provided in the scoring instructions of the CESD-R or PHQ-9 questionnaires. In one example, the scores may be associated with the following depression diagnoses:
A. 0: No depression
B. 1-4: Minimal depression
C. 5-9: Mild depression
D. 10-14: Moderate depression
E. 15-19: Moderately severe depression
F. 20-27: Severe depression

Test score statement 804 and diagnostic statement 806 may be configured to communicate the depression diagnosis to a user. In the examples illustrated in FIGS. 8A-8B, a minimal depression or mild depression diagnosis may cause diagnostic statement 806 to read “You are Normal.” Further, a no depression diagnosis may cause diagnostic statement 806 to read “You do not screen positive for depression.” Diagnostic statement 806 may state the depression condition (i.e., Moderate, Moderately severe, or Severe in the other cases).

Further, in the example illustrated in FIGS. 8A-8B, intervention statement 808 and user selections buttons 810 may be provided based on the above scores as follows:
A. [No statement displayed] (OK and Still need help user selection buttons).
B. “No intervention suggested at this time.” (OK and Still need help user selection buttons).
C. “We suggest that you seek help from behavioral health professional.” (Ok and Get help user selection buttons).
D. “We suggest that you seek help from behavioral health professional.” (Ok and Get help user selection buttons).
E. “We suggest that you seek help from behavioral health professional.” (Ok and Get help user selection buttons).
F. “We suggest that you seek help from behavioral health professional.” (Ok and Get help user selection buttons).

In some examples, a particular answer to a particular question may override one of the diagnostic statement 806, intervention statement 808 and/or user selections buttons 810 associated with a score. For example, if a question is “Feeling like I wanted to harm myself,” an answer of “Nearly every day,” may cause intervention statement to read “Please call a crisis hotline immediately,” regardless of the total score. It should be noted that in some examples, test module 304 may be configured to communication with communications network 104 such that a screening test may be updated with new questionnaires, new diagnosis algorithms, and new interventions.

Upon a user selecting an Ok user selection button, computing device 202 may provide menu graphical user interface 400 or test graphical user interface 500, described above. Upon a user selecting a Still need help user selection button a scoring explanation may be provided to a user and/or a button that causes computing device 200 to call a hotline may be provided to a user. The scoring explanation may be the detailed explanation described above or a simplified explanation (e.g., “1-9: minor,” “10-19: moderate,” and “20: severe”). Upon the user selecting a Get help user selection button, a list of hotlines and resources may be provided to a user or Get help user selection button may cause computing device 200 to call a hotline. In some examples, a user selection of one of the user selections buttons 810 may cause computing device 200 to transmit test results to a healthcare professional, such as a patient's treating psychiatrist or a healthcare professional that may provide immediate intervening treatment in the case of a severe diagnosis.

Referring again to FIG. 3, reporting module 312 may be configured to report results to a healthcare professional according to one or more reporting settings. Reporting module 312 may be configured to enable a healthcare provider to securely copy scores of questionnaires stored on computing device 200 to a healthcare professional's computing device along with dates, times, and corresponding user moods. In some examples, dates, times, and corresponding user moods may be reported as trends (e.g., mood over a time period, such as a week). In some examples, scores may be reported to a healthcare profession when a user enables scores to be reported. In some examples, scores may be reported to a healthcare professional using a secure access mechanism (e.g., passcodes validated by support engine 116). In other examples, it may be safer to store data only on computing device 200 and transfer data to a healthcare profession over a secured wired connection (e.g., USB). In this manner, computing device 200 may be configured to provide information to a healthcare professional while providing an appropriate level of privacy for a user.

FIGS. 9-13 are examples of graphical user interfaces that may be provided by a computing device to implement one or more techniques of this disclosure. The graphical user interfaces illustrated in FIG. 9-13 represent examples of graphical user interfaces that may be provided in conjunction with functions associated with SAM module 306. SAM module 306 may be configured such that users are able to record their sleep patterns, activity logs, and mood patterns on a daily, weekly, or monthly basis. As described below, SAM module 306 may generate reports for a user and one or more healthcare professionals.

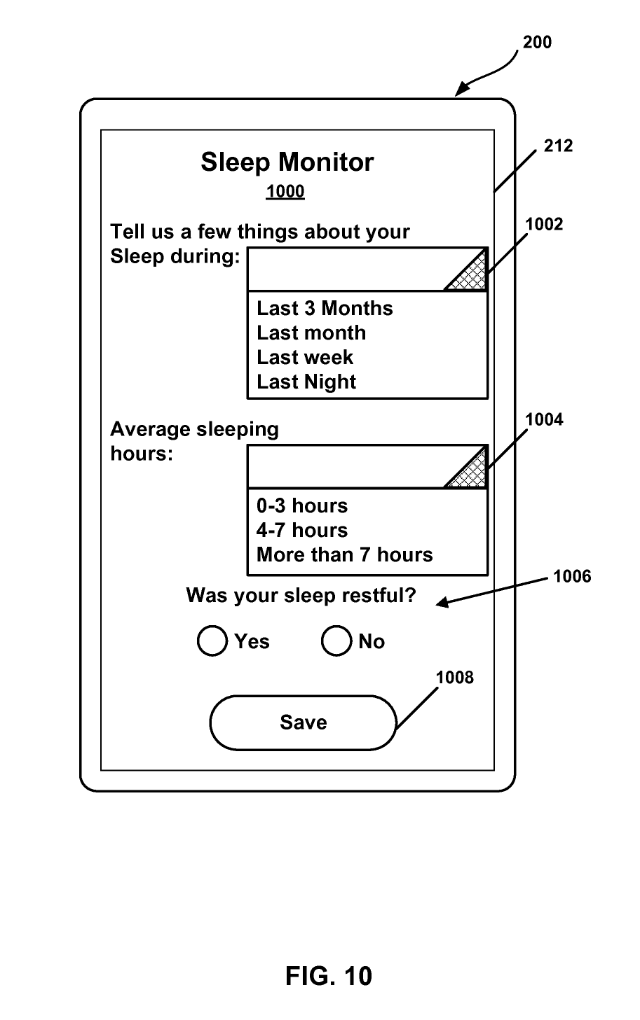

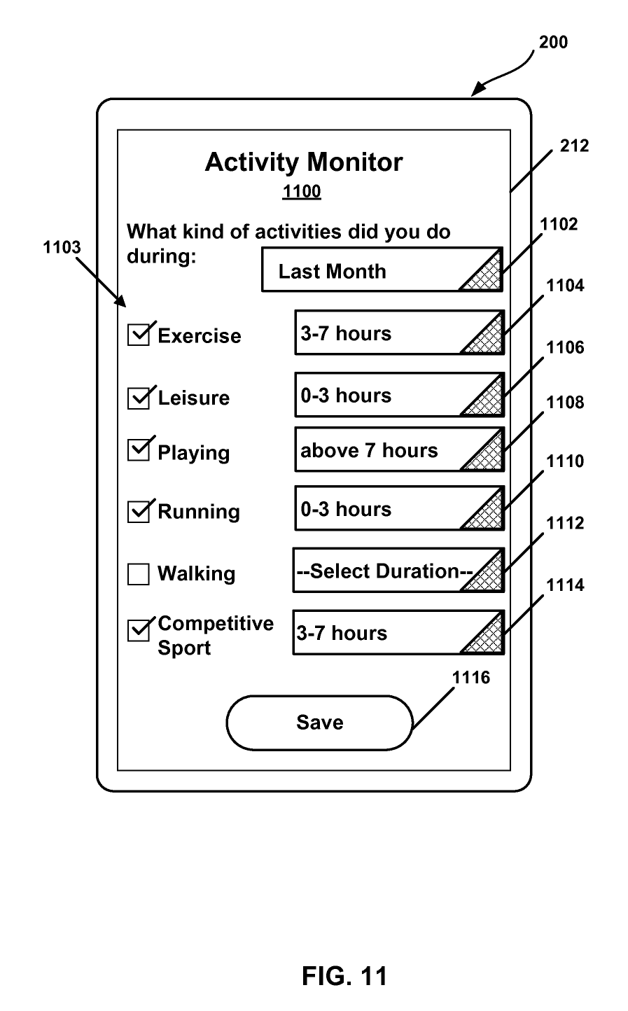

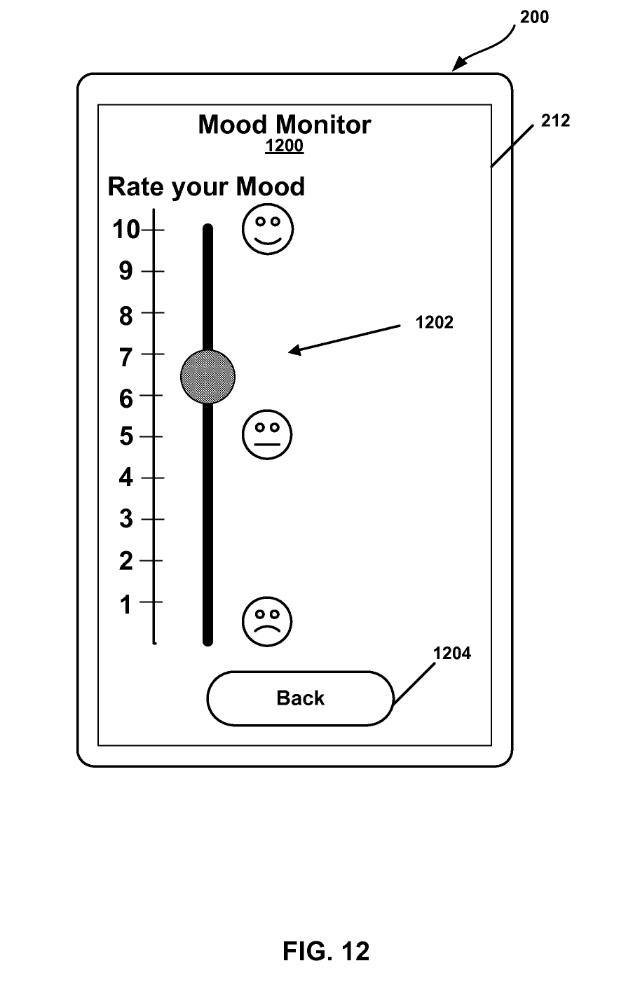

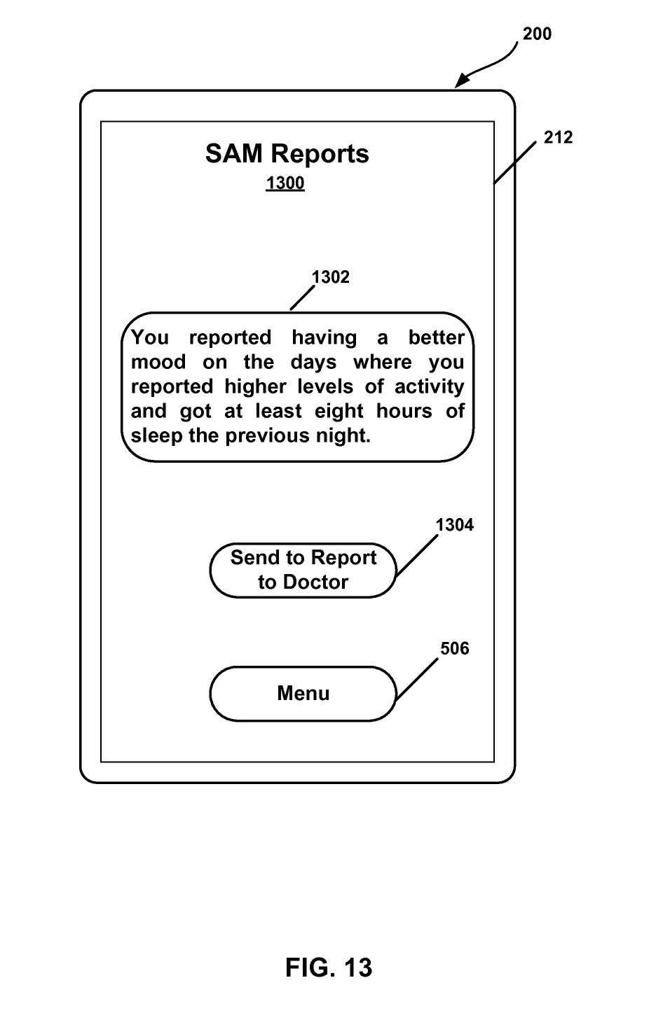

As illustrated in FIG. 9, sleep, activity, mood monitor graphical user interface 900 includes sleep monitor icon 902, activity monitor icon 904, mood monitor icon 906, SAM reports icon 908, and menu icon 506 described above. Upon selection of sleep monitor icon 902, computing device 200 may provide sleep monitor graphical user interface 1000 illustrated in FIG. 10. Upon selection of activity monitor icon 904, computing device 200 may provide activity graphical user interface 1100 illustrated in FIG. 11. Upon selection of Activity Monitor icon 904, computing device 200 may provide activity graphical user interface 1200, illustrated in FIG. 12. Upon selection of SAM Reports icon 908, computing device 200 may provide SAM reports graphical user interface 1300 illustrated in FIG. 13.

As illustrated in FIG. 10 sleep monitor graphical user interface 1000 includes sleep questions and drop down menus 1002 and 1004, sleep question and answer selection 1006, and save icon 1008. Sleep drop down menu 1002 enables a user to select one of several monitoring periods. In some examples, a sleep monitoring period may be set to a default value based on, for example, an interval set by a health care professional. Sleep drop down menu 1004 enables a user to select one of several average amounts of sleep for the selected monitoring period. Select question and answer 1006 enables a user to indicate if the sleep during the monitoring period was restful. Save icon 1008 allows a user to save the selections provided in sleep monitor graphical user interface 1000. As described in detail below, the sleep monitor selections may be used by a health care professional to diagnosis a psychiatric disorder and/or may be used to provide feedback to a user.

As illustrated in FIG. 11 activity monitor graphical user interface 1100 includes activity monitoring period drop down menu 1102, activity selection buttons 1103, exercise drop down menu 1104, leisure drop down menu 1106, playing drop down menu 1106, running drop down menu 1110, walking drop down menu 1112, competitive sport drop down menu 1114 and save icon 1116. In a manner similar to sleep drop down menu 1002, described above, activity monitoring period drop down menu 1102 enables a user to select one of several monitoring periods. Activity selection buttons 1103 enable a user to select one or more activities that the user participated in during the selected monitoring period.

Upon an activity being selected, a user will be enabled to select an amount of time using the corresponding drop down menu, (e.g., Exercise is selected, drop down menu 1104 allows user to select a time period). Similar to save icon 1008, described above, save icon 1116 allows a user to save the selections provided in activity monitor graphical user interface 1100. It should be noted, in some examples, activity monitor graphical user interface 1100 may include a social activity button and a corresponding drop down menu that enables a user to select the following types of social activities: positive, neutral, and negative. For each of the types of social activities a drop down menu may be provided that enables a user to select a corresponding amount of time. As described in detail below, the activity monitor selections may be used by a health care professional to diagnosis a psychiatric disorder and/or may be used to provide feedback to a user.

As illustrated in FIG. 12, mood monitor interface 1200 includes a slider 1202 that enables a user to select whether the users mood is generally positive, neutral, or negative. In the example, illustrated in FIG. 12 SAM module 306 may continuously monitor a user's indicated mood. In one example, the faces illustrated in FIG. 12 may change as a user moves the position of slider 1202. Upon the user selecting the back icon 1204, the user may be returned to sleep, activity, mood monitor graphical user interface 900. As described in detail below, mood monitor selections may be used by a health care professional to diagnosis a psychiatric disorder and/or may be used to provide feedback to a user.

As illustrated in FIG. 13, SAM reports module includes a report message 1302, a send report to doctor icon 1304, and menu icon 506 as described above. Report message 1302 may provide feedback information to the user, such that the user can correlate reported moods to at least one of sleep habits or activity level. In this manner, user may use feedback information provided in report message 1302 to modify behavior to mitigate symptoms associated with a psychiatric disorder. Further, report message 1302 may enable a user to correlate at least one of sleep habits or activity levels to the severity of a user's condition. It should be noted that in other examples, feedback may be provided in a graphical form. For example, reported social activity minutes may be included in a line plot where a red portion of a line indicates a negative reported mood, a yellow portion of a line indicates a neutral reported mood, and green portion of a line indicates a positive reported mood. A user selection of send report to doctor icon 1304 may cause computing device 200 to transmit SAM monitor information, including reports, to a healthcare professional. In one example, reporting module 312 may be configured transmit SAM monitor information to a healthcare professional according to one or more reporting settings. In this manner, SAM module 306 may generate reports for a user and one or more healthcare professionals. In some examples, reports may include trends of reported activities and corresponding mood (e.g., activities and corresponding moods over a time period, such as a week).

Referring again to FIG. 3, happy place module 308 may be configured to provide multimedia, including, for example, messages received by computing device, to alleviate symptoms caused by the psychiatric disorder. FIG. 14 is an example of a graphical user interface that may be provided by a computing device to implement one or more techniques of this disclosure. The graphical user interface illustrated in FIG. 14 represents an example of a graphical user interface that may be displayed in conjunction with functions associated with happy place module 308. Happy place module 308 may be considered a repository where users can catalog and/or store items (e.g., like pictures, website links, etc.) that make them happy. For example, when a user is feeling depressed the user may watch a video that makes the user laugh. Items may be selected by a user and/or a healthcare professional and may be referred to as therapeutic multimedia. In one example, items may be stored on computing device 200. In another example, items may be stored in database 120 illustrated in FIG. 1.

As illustrated in FIG. 14, happy place graphical user interface 1400 includes music icon 1402, videos icon 1404, pictures icon 1406, messages icon 1408, and menu icon 506 described above. Upon selection of music icon 1402, a user may be presented a list of songs that the user and/or a healthcare professional have selected to alleviate one or more symptoms of a psychiatric disorder. A user may select a particular song from the list of songs. Upon selection of videos icon 1404, a user may be presented a list of videos that the user and/or a healthcare professional have selected to alleviate one or more symptoms of a psychiatric disorder. Upon selection of pictures icon 1406, a user may be presented a list of pictures that the user and/or a healthcare professional have selected to alleviate one or more symptoms of a psychiatric disorder. Upon selection of message icon 1406, a user may be presented a list of one or more text messages, emails, voicemails, or website links. The list of messages may be generated by messages selected by the user and/or a healthcare professional or may be generated using an algorithm (e.g., keyword search of positive terms to find positive messages). In this manner, happy place graphical user interface 1400 represents an example of a graphical user interface configured to alleviate symptoms caused by the psychiatric disorder.

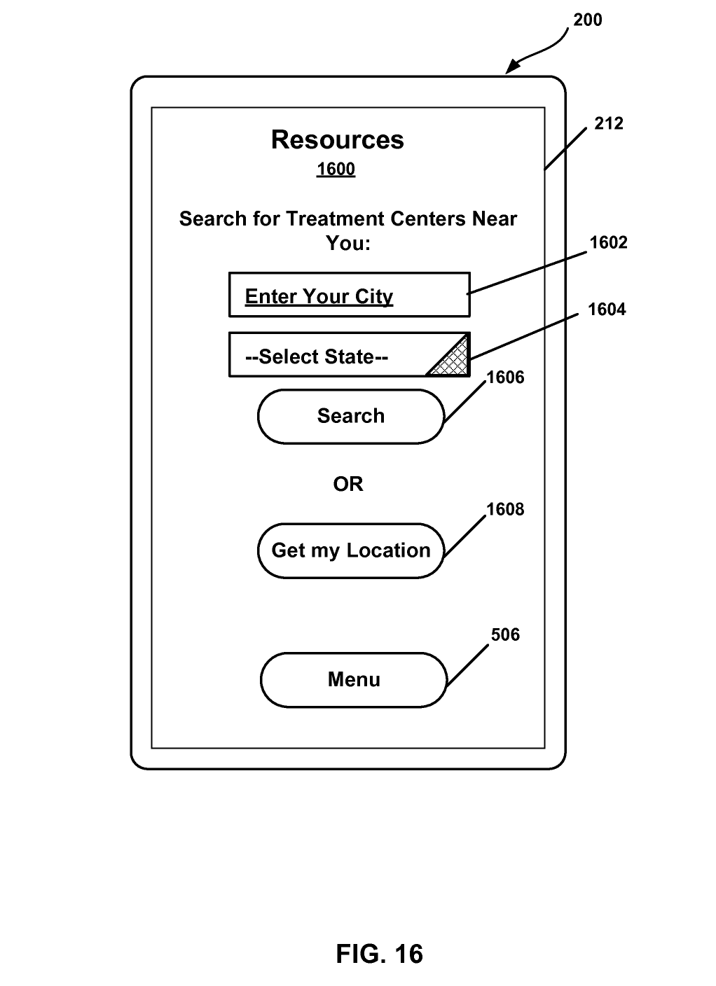

Referring again to FIG. 3, resources module 310 may be configured to provide resources to a user that may alleviate symptoms caused by the psychiatric disorder. For example, resources may include links and/or phone numbers to local mental health clinics and hospitals. FIG. 15 is an example of a graphical user interface that may be provided by a computing device to implement one or more techniques of this disclosure. The graphical user interface illustrated in FIG. 15 represents an example of a graphical user interface that may be displayed in conjunction with functions associated with resources module 310. As illustrated in FIG. 15, resources graphical user interface 1500 includes treatment centers icon 1502, hotlines icon 1504, support groups icon 1506, websites icon 1508, and menu icon 506 described above. Upon selection of treatment centers icon 1502, a list of treatment centers may be provided based on a user's location or resources graphical user interface 1600 illustrated in FIG. 16 may be provided to determine a user's location. Upon selection of hotlines icons 1504, a list of hotlines corresponding to one or more psychiatric disorders may be provided. For example, if a user is depressed, a list of depression related hotlines, including suicide prevention hotlines, may be provided. Upon selection of support groups icon 1506, information regarding support groups for one or more psychiatric disorders may be provided. Support group information may include information about a local chapter of a support group (e.g., meeting times for a local alcoholics anonymous chapter). Further, support group information may include information regarding a web-based community support group. In one example, a web-based community support group may include user of diagnosis and treatment application 220 who have indicated that they are available to provide support to other users of diagnosis and treatment application 220. Upon selection of website icon 1508, links to websites that provide information regarding a psychiatric disorder may be provided. In one example, a link to the National Alliance of Mental Illness (NAMI) may be provided. In this manner, resources graphical user interface 1500 represents an example of a graphical user interface configured to alleviate symptoms caused by the psychiatric disorder.

As describe above, some resources may be location based, e.g., treatment centers. FIG. 16 illustrated an example of a graphical user interface that enables a user to provide a location so location based resources may be provided by computing device 200. As illustrated in FIG. 16, resources graphical user interface 1600 includes Enter your city text box 1602, select state drop down menu 1604, search icon 1606, get my location icon 1608, and menu icon 506 described above. Enter your city text box 1602 enables a user to type in the name of the city where the user is located. In some examples, computing device 200 may be configured to auto-complete a city name after a user enters one or more characters. Select state drop down menu 1604 enables a user to select a state where the user is located. After a user enters a city and a state, a user may select the search icon 1606 and a list of local resources, such as, local treatment centers may be provided. As an alternative to entering location information, a user may select the get the get my location module 1608. Upon selection of get my location icon 1608 diagnosis and treatment application 220 may retrieve location information from computing device 200. For example, if computing device 220 is a smartphone, diagnosis and treatment application 220 may retrieve location information from the smartphone and a list of local resources may be provided based on the retrieved location information. It should be noted that although the example graphical user interfaces described above are described as including particular user entry elements (e.g., drop down menus, radio buttons, etc.), where appropriate other graphical user elements may be used to enable a user to enter information.

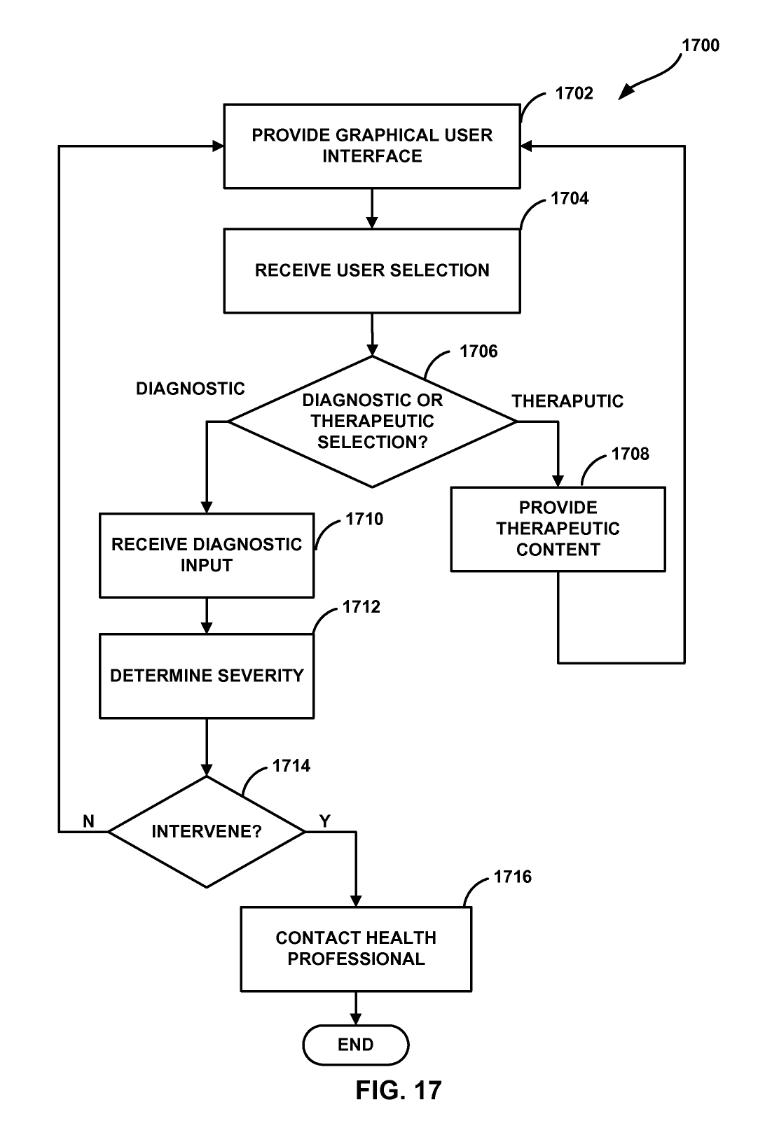

FIG. 17 is a flowchart illustrating an example method for diagnosing and treating a psychiatric disorder according to the techniques of this disclosure. Computing device 200 provides a graphical user interface (1702). In one example, the graphical user interface may be menu graphical user interface 400 described above. Computing device 200 receives user selection (1704). In one example, user selection may be one of take test icon 402, sleep activity mood icon 404, happy place icon 406, and resources icon 408 described above. Computing device 200 determines whether the selection corresponds to one a diagnostic or therapeutic selection (1706). In one example, selections of take test icon 402 and sleep activity mood icon 404 correspond to a diagnostic selection and selections of happy place icon 406 and resources icon 408 correspond to therapeutic selections. If a selection is a therapeutic selection, computing device 200 provides therapeutic content (1708). In one example, therapeutic content may include multimedia, resources, or reports. If a selection is a diagnostic selection, computer device 200 receives diagnostic input (1710). In one example, diagnostic information may include information received in accordance with the operation of test module 304 and/or SAM 306 as described above. Computer device 200 determines the severity of a user's condition based on the received diagnostic input (1712). Based on the severity of a user's condition computing device 200 may determine whether to intervene (1714). In one example, computing device 200 may provide resource information described above to a user. Resources information may be used to contact a healthcare professional (1716). In one example, a user may initiate the contact. In other examples, computing device 200 may initiate contact based on the determine severity (e.g., auto dial a suicide prevention hotline if suicidal behavior is detected). In this manner, computing device 200 represents an example of a device configured to provide a graphical user interface that enables a user to select at least one of: entering information related to a diagnosis of the psychiatric disorder and alleviating symptoms caused by the psychiatric disorder, and upon the user selecting entering information related to the diagnosis of a psychiatric disorder, receive information related to the diagnosis of the psychiatric disorder, determine the severity of a user's condition based at least in part on the received information, and provide a treatment based on the determined severity of the user's condition.

As described above, reports may be provided to a healthcare professional or a user based on user reported information. In another example, reports may be provided based on user reported information and/or computing device usage information. In “Associating Internet Usage with Depressive Behavior among College Students,” IEEE Technology & Society Magazine, Volume 31, No. 4, Winter 2012, which is incorporated by reference in its entirety, techniques are described for associating internet usage with depressive behavior. In one example, a report may be generated based on internet usage and reported behavior. For example, if a user reports low levels of sleep and is using a computing device to browse the Internet late at night, a report indicating severe depression may be generated. In another example, scores of questionnaires may be integrated with, for example, Internet key word searches, and/or Facebook posts.

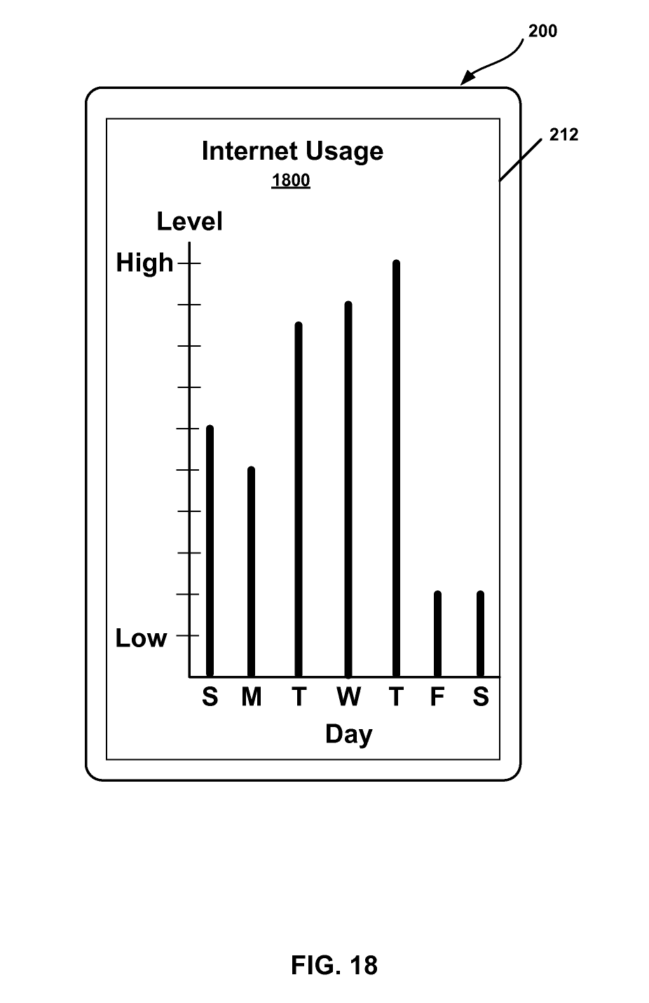

Further, in one example a healthcare professional may use usage data to verify user reported behavior. For example, a healthcare professional may be able to verify reported amounts of sleep based on the times a user is accessing the internet. FIG. 18 is an example of a graphical user interface that may be provided by a computing device to implement one or more techniques of this disclosure. Internet usage graphical user interface 1800 represents an example of a graphical user interface that may be provide to a healthcare professional as device usage report. As illustrated in FIG. 18, levels of internet usage for each day of a week included in internet usage graphical user interface 1800.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for diagnosing and treating a psychiatric disorder, the method comprising:
providing a graphical user interface that enables a user to select at least one of: entering information related to a diagnosis of the psychiatric disorder and alleviating symptoms caused by the psychiatric disorder; and
upon the user selecting entering information related to the diagnosis of a psychiatric disorder,
receiving information related to the diagnosis of the psychiatric disorder,
determining the severity of a user's condition based at least in part on the received information; and
providing a treatment based on the determined severity of the user's condition.

2. The method of claim 1, wherein the psychiatric disorder includes at least one of depression, anxiety, stress, or anorexia.

3. The method of claim 1, wherein receiving information related to the diagnosis of a psychiatric disorder includes receiving information related to one or more of: a user's sleep habits, a user's activity level, or a user's mood.

4. The method of claim 1, wherein providing a treatment based on the determined severity includes contacting a health care professional.

5. The method of claim 1, wherein providing a treatment based on the determined severity includes displaying feedback information to the user, such that the user can correlate at least one of sleep habits or activity level to the severity of the user's condition.

6. The method of claim 1, further comprising upon the user selecting alleviating symptoms associated with the psychiatric disorder, providing a graphical user interface that enables the user to select therapeutic multimedia, wherein the therapeutic multimedia has been selected by the user or a healthcare professional.

7. The method of claim 1, further comprising transmitting the received information related to the diagnosis of the psychiatric disorder to a health care professional.

8. A device for diagnosing and treating a psychiatric disorder, the device comprising:
one or more processors configured to:
provide a graphical user interface that enables a user to select at least one of: entering information related to a diagnosis of the psychiatric disorder and alleviating symptoms caused by the psychiatric disorder, and
upon the user selecting entering information related to the diagnosis of a psychiatric disorder,
receive information related to the diagnosis of the psychiatric disorder,
determine the severity of a user's condition based at least in part on the received information; and
provide a treatment based on the determined severity of the user's condition.

9. The device of claim 8, wherein the psychiatric disorder includes at least one of depression, anxiety, stress, or anorexia, and wherein the device is a mobile phone.

10. The device of claim 8, wherein receiving information related to the diagnosis of a psychiatric disorder includes receiving information related to one or more of: a user's sleep habits, a user's activity level, or a user's mood.

11. The device of claim 8, wherein providing a treatment based on the determined severity includes contacting a health care professional.

12. The device of claim 8, wherein providing a treatment based on the determined severity includes displaying feedback information to the user, such that the user can correlate at least one of sleep habits or activity level to the severity of the user's condition.

13. The device of claim 8, wherein upon the user selecting alleviating symptoms associated with the psychiatric disorder, the one or more processors are further configured to provide a graphical user interface that enables the user to select therapeutic multimedia, wherein the therapeutic multimedia has been selected by the user or a health care professional.

14. The device of claim 7, further comprising a network interface configured to transmit the received information related to the diagnosis of the psychiatric disorder to a healthcare professional.

15. A non-transitory computer-readable storage medium having instructions stored thereon that upon execution cause one or more processors of a device to:
provide a graphical user interface that enables a user to select at least one of: entering information related to a diagnosis of the psychiatric disorder and alleviating symptoms caused by the psychiatric disorder, and
upon the user selecting entering information related to the diagnosis of a psychiatric disorder,
receive information related to the diagnosis of the psychiatric disorder,
determine the severity of a user's condition based at least in part on the received information; and
provide a treatment based on the determined severity of the user's condition.

16. The non-transitory computer-readable storage medium of claim 15, wherein receiving information related to the diagnosis of a psychiatric disorder includes receiving information related to one or more of: a user's sleep habits, a user's activity level, or a user's mood.

17. The non-transitory computer-readable storage medium of claim 15, wherein providing a treatment based on the determined severity includes contacting a health care professional.

18. The non-transitory computer-readable storage medium of claim 15, wherein providing a treatment based on the determined severity includes providing a graphical user interface that enables the user to select therapeutic multimedia, wherein the therapeutic multimedia has been selected by the user or a health care professional.

19. The non-transitory computer-readable storage medium of claim 15, wherein upon the user selecting alleviating symptoms associated with the psychiatric disorder includes, the instructions cause one or more processors of a device to
provide a graphical user interface that enables the user to select one more therapeutic multimedia, wherein the therapeutic multimedia has been selected by the user or a health care professional.

20. The non-transitory computer-readable storage medium of claim 15, wherein the instructions further cause one or more processors of a device to transmit the received information related to the diagnosis of the psychiatric disorder to a health care professional.
